(19) United States
(12) Patent Application Publication
(10) Pub. No.: US 2006/0149891 A1
(43) Pub. Date: Jul. 6, 2006

(54) Relocated reclaim block

(76) Inventor: John C. Rudelic, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,802

(22) Filed: Dec. 30, 2004

(51) Int. Cl. G06F 12/00

(52) U.S. Cl. 711/103; 711/170

(57) ABSTRACT

In a memory, a reclaim block is relocated. Memory management may employ an algorithm to determine how to determine which of multiple blocks to use as a reclaim block. The block selected as the reclaim block may be used as the reclaim block for a number of write cycles, program rewrites, etc., and may subsequently be switched.

### FIELD

Embodiments of the invention relate to memory devices, and specifically to code memory management.

### BACKGROUND

Memory or memory devices, for example, non-volatile memory and flash storage, may store data and/or code. Data may be values accessed for execution of a program to influence an outcome of an algorithm or operation. Code may be instructions and/or operation information to control/direct execution of an electronic device. Instructions may indicate the function and/or state of control logic. Data is typically randomly accessed by specifically addressing the data desired. Thus, location of data within a memory volume is generally of little significance. Code is typically accessed in contiguous order of the code section of memory locations for execution. In parallel computing, pipelined, hyperthreading, predictive branching, and/or variable-length instruction word machines, for example, one or more bytes of code, or a block, may be accessed simultaneously. Thus, code may be accessed in blocks, which increases the significance of having one section of code adjacent to another section of code, and reduce the amount of free space between valid code or code objects.

Additionally, there may be advantage to having all code sections contiguous and adjacent to one another, from the first byte to the last, to create the largest section of free code space possible. Code management filesystems may be designed to manage the code section in a way to create the largest section of free code space possible. This may include the use of a code coalescing function in the code management, which aggregates sections of code together to remove gaps that may result from deleting one or more code bytes/objects. Coalescing code may include the use of a reclaim block, a section of the code volume to which a code section may be copied to recover valid objects and eliminate free space. Traditional approaches use a specific, fixed block as the reclaim block.

However, memory blocks in non-volatile memory have physical limitations on rewrite capabilities. If a memory location has exceeded its threshold number of write cycles, it may be unable to hold a determinate state, and thus will cease to be useful as a memory location. Some memory technologies have cycle counts of approximately 100,000 cycles, and many next-generation devices may have lower cycle counts. For example, next-generation NOR flash devices may have lower cycle limits than the current device limitation of approximately 1,000,000 cycles. Memory devices have steadily increased in capacity, as has the volume of code storage placed in the memory devices. The number of reclaims can be proportional to the number of blocks to be managed, the number of objects per block, and the method of updating the individual objects. Because of the increased size of programs stored in executable memory code, and the potential frequent repetitive use of the reclaim block, the use condition curve of a reclaim block may be an exponential curve, which may create a circumstance where the reclaim block exceeds its maximum cycle count.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is an embodiment of a block diagram of a memory having a relocatable reclaim block.

FIG. 2 is an embodiment of a block diagram of a memory device having managed blocks with movable reclaim blocks.

FIG. 3 is an embodiment of a flow diagram of reclaiming a memory block.

FIG. 4 is an embodiment of a flow diagram of switching a reclaim block.

FIG. 5 is an embodiment of a block diagram of an electronic device having a flash with a dynamically designated reclaim block.

### DETAILED DESCRIPTION

A code management filesystem may introduce variability into the utilization of the reclaim block. One example of code management that may introduce such variability is the Flash Data Integrator (FDI), which is a data manager on one or more flash devices available from Intel Corporation of Santa Clara, Calif. Introducing variation of code block selection for the reclaim block, as opposed to having a fixed reclaim block may reduce the number of cycles that any single block will experience, and thus reduce the risk of overrunning the cycle count threshold.

Dynamic selection of the block to be used as the reclaim block may be accomplished by having a pool of potential reclaim blocks, or blocks that can be used for reclaiming codes blocks, rather than using the same physical cell/memory location/block for every reclaim. A pool of reclaim blocks may be a portion up to all of the blocks of a managed volume, with the reclaim block being selected from out of the pool according to a reclaim block selection algorithm. A pool of reclaim blocks may not necessarily consist of only adjacent or contiguous blocks, although it may. Additionally, even in an implementation where a pool of reclaim blocks includes one or more adjacent blocks, the adjacent blocks may not necessarily be selected sequentially as the reclaim block. Rather, wherever the reclaim block of a pool of blocks is located physically within the managed volume, a selection algorithm may determine which block of the pool to next select as the reclaim block, which algorithm may or may not consider physical proximity and/or adjacency.

In one embodiment an algorithm may be employed that implements one or more counters to track use of a reclaim block and influence a determination to switch reclaim blocks. The following implementation suggestions are intended to be illustrative only, and in no way be limiting or representative of a complete list of possible implementations. In one embodiment the implementation of one or more counters includes the use of a global counter to track a number of reclaims and/or delete operations performed on blocks of the managed code volume. A counter may be incremented/decremented each time a delete function in the code management is called. A counter may be incremented/decremented each time a reclaim operation is executed. A global cycle counter may be introduced to maintain a list containing the cycle count for one or more blocks that are managed. Individual counters may be kept, for example, in a list, to indicate cycle count information for an individual block. Information based on the global counter and/or the individual counters can be stored in a data manager or in a specific section of the code managed volume. Note that excessive variableness, a large reclaim block pool, and/or frequent changing/switching of the reclaim block, among other things, may introduce overhead in data storage and/or processing to provide the dynamically designated/selected reclaim block. One or more of these factors may be adjusted according to specific implementations to control the overhead.

Algorithms may trigger/indicate a reclaim block switch if a threshold number of a counter has been reached, switch after each reclaim/delete operation, switch when the cycle limit has been reached on a block, or another criterion. Blocks that have reached a threshold number of cycles (e.g., one or more, up to the cycle limit) may be removed from a reclaim block pool, moved to the end of the pool, or placed back into the pool. Blocks that reach and/or exceed their cycle count limit may be removed from the pool and/or disabled. Counter-based algorithms may include a last-in-first-out (LIFO) implementation, a random selection implementation, and/or a round robin implementation. In one embodiment the selection algorithms assume free blocks exist or that the user can be signaled to delete enough code to reduce the volume by a single block. In one embodiment the algorithms check a selected block to determine that the block has a sufficient number of cycles left to operate as the reclaim block. A number of cycles may be sufficient if it is a greater number than the expected number of cycles the block will act as the reclaim block prior to the next switch, if it is greater than or equal to 1, and/or if it is greater than a implementation-specific pre-selected value.

A LIFO implementation may involve beginning at the end of the reclaim block pool, and decrementing through the pool. In one embodiment a reclaim block at the end of the pool is used as the reclaim block until the cycle limit has been reached on the block, and then the block address/indicator/identifier/pointer may be decremented to indicate the next to last block. This may continue as the code management “consumes” the managed volume. The blocks that have reached the end of their useful life may be disabled as memory blocks in the volume and/or deleted from the reclaim block pool.

A random selection algorithm may select the reclaim block in a random or pseudo-random fashion. For example, the algorithm may generate a random number to be used to provide a random index. The random index indicates one or the reclaim blocks in the pool. The randomly indexed block may be selected as the next reclaim block. The indicated reclaim block may be checked to determine if it has cycle counts available. If it does, it may be selected as the next reclaim block.

A round robin algorithm may select the reclaim block based on a chosen/hardcoded pattern, or a round robin fashion. For example, a list may be maintained to indicate which of the blocks in the pool is next in line to be used as the reclaim block. If the next block on the list is available to use as a reclaim block, it may be selected as the next reclaim block.

In one embodiment an algorithm may be employed that operates independently of counters. The algorithm may switch reclaim blocks without determining a number of cycles and/or delete routines performed. In one embodiment an algorithm may operate without the overhead associated with maintaining lists of reclaim blocks in a pool and/or information relating to the blocks in the pool. Examples of counter-less reclaim block switching algorithms may include a first free block algorithm or a random selection algorithm.

A first free block algorithm may simply select/designate the first free block in sequential order from the occupied code blocks as the reclaim block. Thus, when a device is new, the reclaim block will be near the beginning of the volume, and as the code volume fills, the reclaim block will be pushed toward the last block of the volume. This mechanism introduces the variability naturally as the user consumes the flash volume.

A random selection algorithm may simply generate a random index and select a block. This may occur at each iteration of the reclaim routine. If the block is occupied with code, a different block will be selected. If the block is unoccupied, the block may be selected as the reclaim block for the reclaim. This mechanism may rely on the probability that a random selection will likely not repeatedly select the same block and overrun the cycle count of the reclaim block during the useful life of a device having the memory.

Various references herein to an “embodiment” are to be understood as describing a particular feature, structure, or characteristic included in at least one embodiment or implementation of the invention. Thus, the appearance of phrases such as “in one embodiment,” or “in alternate an embodiment” may describe various embodiments of the invention, and may not necessarily all refer to the same embodiment.

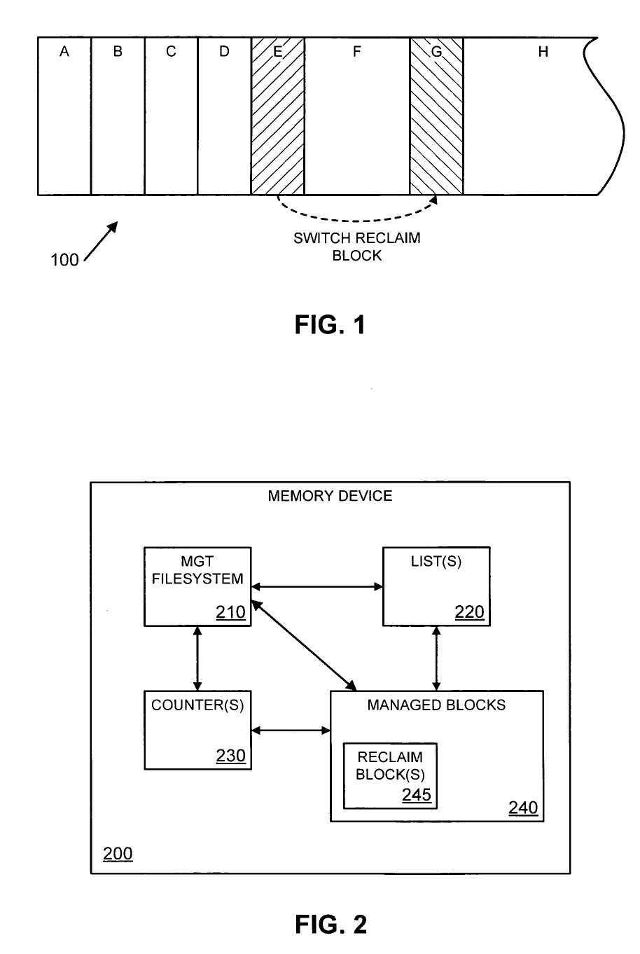

FIG. 1 is an embodiment of a block diagram of a memory having a relocatable reclaim block. A memory may include volume 100 of managed blocks A-H. Blocks A-D may include one or more code objects, which may be one or more bytes of data representing an instruction and/or information relating to an operation of an electronic system. A data object, in contrast, may be information, constant values, etc. In typical implementations, code is read in contiguous groups of code bytes to provide data for pipelining, branch prediction, hyperthreading, etc. The number of bytes read or accessed as a group of code bytes is implementation specific, and may be 1, 2, 4, 8, or some other number. Either the number of bytes read or accessed simultaneously, or some other number of bytes may be considered to be a block of code. Data objects are typically addressed individually, and thus may not necessarily be read in blocks.

Because code may be read in blocks, many code management filesystems manage the code by aggregating all code in contiguous locations, without free space, or empty bytes, in between the objects. The code management may attempt to create the largest free space possible; therefore, the code management may place all code at the beginning of the managed volume, beginning with the first available memory location, and all other code objects adjacent to the one before it. In this way the largest free space possible may be available at the end of the occupied memory locations. In managing code in such a manner, deletion of code bytes and/or objects may invoke the management to coalesce the code, or aggregate the code objects, eliminating free spaces that may be created in deleting certain bytes/objects.

Reclaim block E may be used to coalesce the code memory. A block, for example, block B, having a deleted object may be copied to the reclaim block, the valid objects coalesced, and stored back into the original block. The management may then push this free space out to the end of the code in successive iterations of block reads and copies, to coalesce blocks C and D.

In one embodiment a management filesystem switches from using block E as the reclaim block to block G, which may represent another block in the reclaim block pool. The reclaim block pool may be some or all of the blocks in volume 100. A block may be selected based on one or more selection protocols/mechanisms/algorithms, such as random selection, next available block, or round robin. In one embodiment the number of code delete operations is monitored by the management filesystem. A code delete operation may be expected to generate use of the reclaim block. Thus, after a number of code delete operations are performed, the management filesystem may trigger a reclaim block switch.

In one embodiment a cycle count is monitored for each block in a reclaim block pool, the pool including some or all of the blocks in volume 100. If a block is selected from among the pool, the cycle count of the individual selected block may be checked to determine if it has enough cycles to act as a reclaim block. In another embodiment, a block acting as the current reclaim block may be monitored individually to determine if the individual cycle count of the reclaim block exceeds a threshold. If the cycle count exceeds a threshold, a reclaim block swap may be triggered, and another reclaim block selected.

FIG. 2 is an embodiment of a block diagram of a memory device having managed blocks with movable reclaim blocks. Memory device 200 represents one or more circuits, including control logic and/or control software/firmware and memory/storage cells/locations. Memory device 200 may be, for example, read only memory (ROM), electronically erasable programmable read only memory, flash, or other non-volatile memory. Memory device 200 includes management filesystem 210, which represents hardware and/or software to manage a volume of managed blocks 240. Managed blocks 240 may include one or more blocks having stored code objects. Management filesystem 210 may reclaim memory blocks if/when one or more bytes of memory code are deleted.

Managed blocks 240 may include one or more reclaim blocks 245. One or more of reclaim blocks 245 is used to reclaim code blocks when one or more deletes occurs. The selection of which reclaim block or block to use for the reclaiming may be dynamic, and the block selected based on a selection routine.

Management filesystem 210 may include multiple routines to perform operations to manage managed blocks 240 and/or select reclaim block 245. These may include a write routine to store one or more code objects to a location of managed blocks 240, a read routine to generate a pointer to an object to pass to a microcontroller, processor, etc., external to memory device 200, a delete routine to delete a code block/object, a reclaim routine to coalesce code that has one or more empty/free memory locations, and a swap or switch routine to determine when a switch of the reclaim block may occur and identify the new reclaim block. Deleting a code block/object may indicate that the filesystem invalidates the block from any use, and/or invalidates and/or removes the contents, and/or removes a valid tag for a location that indicates reliable information. Deleting a code block may mean resetting all bits in the location to a certain state. In one embodiment the delete routine may invoke the use of the reclaim routine. In one embodiment the reclaim routine may be considered to invoke the reclaim block, e.g., by referencing the block, by copying content to/from the block, and/or performing other operations with the block.

In one embodiment memory device include one or more lists 220, which may include file headers and/or associated file information. Lists 220 may include lists relating to the management of managed blocks 240, for example, cycle counts reclaim block pool(s), etc. Memory device 200 may also include counter 230, which represents one or more mechanisms to track cycle information and/or delete routine information for management filesystem 210. Counter 230 may be as simple as a running variable to a hardware counter.

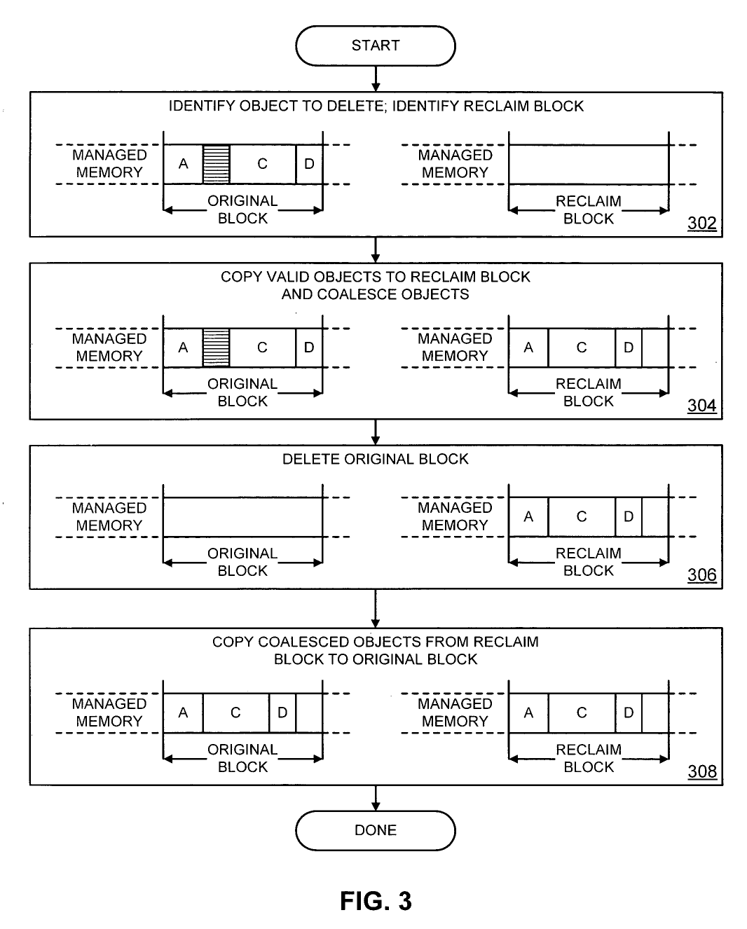

FIG. 3 is an embodiment of a flow diagram of reclaiming a memory block. A code management filesystem may identify an object to delete and identify a reclaim block with which to recover one or more valid data objects in the data block to be deleted, 302. An original block has objects A, B, C, and D, where object B is marked for deletion. The reclaim block may be empty, or have no valid data currently in it. The reclaim block may be selected based on a selection algorithm, as discussed previously, or may have been selected previously based on a selection algorithm, prior to identifying the object to delete. The reclaim block is dynamically designated in that it may be selected from among available blocks in a pool and relocated from one current reclaim block to a different block.

The filesystem may then copy the valid objects to the selected reclaim block and coalesce the valid objects, 304. Because object B is marked for deletion, it may not be copied to the reclaim block. Because the objects are coalesced, object C will become adjacent to object A, and will remain adjacent to object D. The free space from the deleted object is pushed to the back of the block, and may be eliminated on other iterations of a reclaim process, or other coalescing process.

The filesystem deletes the original block, both the valid objects as well as the object to be deleted, 306. Deleting may include invalidating the memory locations and/or toggling one or more bits of the memory locations. The original block may then be ready to receive the contents of the reclaimed block. The filesystem copies the coalesced objects from the reclaim block to the original block, 308. This may include the incrementing/decrementing of one or more counters, evaluating whether the current reclaim block should be relocated to a different physical location in the managed memory, or one or more of these may be performed in conjunction with one or more operations discussed above.

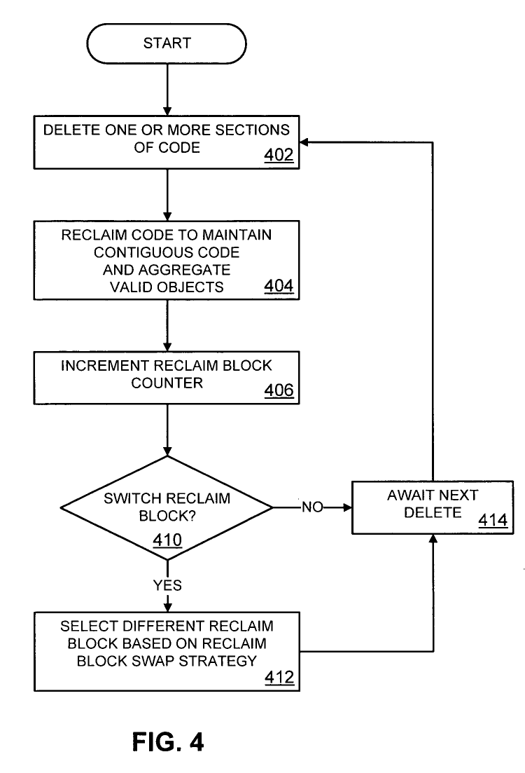

FIG. 4 is an embodiment of a flow diagram of switching a reclaim block. A user may alter code that is stored or to be stored on a memory device, for example, a flash chip, or an on-chip flash in a system on a chip. Altering the code may include deleting one or more lines of code. When the altered code is compiled, there may be one or more section in the code volume of the memory to be deleted, 402. The code management filesystem may control deletion of these sections. Deleting one or more objects in a memory block does not necessarily mean that the entire contents of the memory are invalid. There may be valid objects that the filesystem would like to keep. The filesystem may employ a reclaim block to reclaim the code sections to maintain contiguous code, which may include aggregating valid objects to eliminate free space, 404.

The filesystem may increment one or more counters used to determine whether to relocate the reclaim block and provide information as to whether a block may be used as the next reclaim block, 406. Counters may keep track of cycle count information for one or more blocks of the reclaim block pool, keep track of the number of reclaims, and/or other information. The management filesystem may maintain lists of the information. The filesystem determines whether to switch/relocate the reclaim block, 410. A selection algorithm may determine that the reclaim block should be switched based on one or more criteria, as discussed earlier. The selection algorithm of the particular implementation may determine to select a different reclaim block based on the reclaim block swap strategy of the reclaim selection algorithm, 412. If the reclaim block is not to be switched, or after the different reclaim block is selected, the next delete operation/function is awaited, 414. The next delete may provide the next opportunity to reclaim, and the reclaim block selected may be used then. Note that although shown in FIG. 4 at the end of one potential implementation of a process, selection of the reclaim block may alternatively be performed at the beginning of another potential implementation of the process, for example, just prior to reclaiming the code.

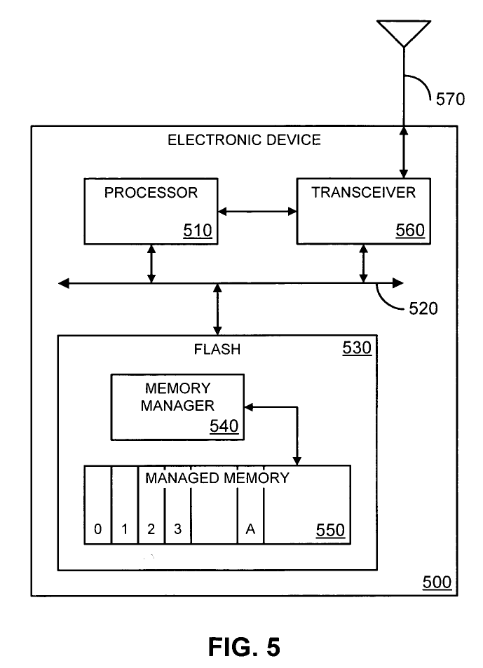

FIG. 5 is an embodiment of a block diagram of an electronic device having a flash with a dynamically designated reclaim block. Electronic device 500 includes processor 510, which represents one or more processors, microcontrollers, digital signal processors (DSPs), etc. Processor 510 may be coupled to bus 520, which represents one or more buses in electronic device 500, and may be a main system bus.

Electronic device 500 includes flash 530, which may be a type of non-volatile memory device/circuit. Flash 530 may include memory manager 540, which may include hardware and/or software to manage code in managed memory 550. Managed memory includes memory blocks 0 to 3 occupied with objects. Block A may be a reclaim block to use in coalescing the objects in blocks 0 to 3 if a code delete occurs.

In one embodiment electronic device 500 includes transceiver 560 coupled to bus 520 and/or processor 510. Transceiver 560 may be coupled through a bus to processor 510, either bus 520 or another bus. Transceiver 560 may be coupled to antenna 570, which represents one or more antenna elements with which to engage in wireless communication. Flash devices are common in wireless communication devices, which may have code upgrades and/or code changes. The volume size and the amount of code stored in the flash devices is increasing. Flash 530 with managed memory 550 with reclaim block A can provide variability in the use of the reclaim block, which may reduce the possibility of overrunning the cycle limit of any particular memory block in managed memory 550.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

1. A method for memory management comprising:
using a selected memory block in a code volume as a reclaim block for the code volume; and
switching from using the selected memory block as the reclaim block to using a different memory block as the reclaim block.

2. A method according to claim 1, wherein switching from using the selected memory block to using the different memory block comprises determining with a selection algorithm the different memory block to use as the reclaim block.

3. A method according to claim 2, wherein the selection algorithm comprises generation of a random memory block index, the randomly generated memory block index to indicate the different memory block to use as the reclaim block.

4. A method according to claim 2, further comprising maintaining a counter to indicate a number of operations performed.

5. A method according to claim 4, wherein the selection algorithm determines to use the different memory block as the reclaim block if the number of operations performed is within a threshold.

6. A method according to claim 4, wherein the counter comprises a global counter, and the number of operations comprises a number of reclaims performed using the selected memory block.

7. A method according to claim 4, wherein the counter comprises a counter to track a number of write cycles performed with the selected memory block.

8. A method according to claim 4, wherein the algorithm comprises a round robin selection algorithm to select the different memory block from among a list of potential reclaim blocks.

9. A method according to claim 4, wherein the algorithm comprises a random selection algorithm to randomly select the different memory block from among available memory blocks, and use the randomly selected second memory block as the reclaim block if the counter indicates that the number of write cycles of the second memory block does not exceed a threshold.

10. An article of manufacture comprising a machine accessible medium having content to provide instructions to result in a machine performing operations, including:
designating a block as a reclaim block;
coalescing the contents of a managed code block to a reclaim block to result in the reclaim block having valid contents of the managed code block in adjacent locations within the reclaim block;
deleting the contents from the managed code block;
copying the coalesced contents to the managed code block to result in the managed code block having the valid contents in adjacent locations within the managed code block; and
designating a different block as the reclaim block.

11. An article of manufacture according to claim 10, wherein the content to provide instructions to result in the machine designating the different block as the reclaim block further comprises the content to provide instructions to result in the machine selecting the different block with a next free block algorithm, to designate the first available code block adjacent to occupied code blocks as the reclaim block.

12. An article of manufacture according to claim 10, wherein the content to provide instructions to result in the machine designating the different block as the reclaim block further comprises the content to provide instructions to designate a new reclaim block after each time content is deleted from the a managed code block.

13. An apparatus for storing data comprising:
a memory having data to define a delete routine to invalidate a portion of code stored in the memory, the delete routine to invoke a reclaim routine to use a reclaim block to coalesce the code, and a swap routine to designate a block of the memory to use as the reclaim block; and
a management filesystem coupled to the memory to execute routines defined in the data.

14. An apparatus according to claim 13, the management filesystem further comprising a counter to indicate a number of times the reclaim block has been invoked by the reclaim routine, the swap routine to designate a different block of memory to use as the reclaim block if the number of times the reclaim block has been invoked exceeds a threshold.

15. An apparatus according to claim 13, the management filesystem further comprising a counter to indicate a number of write cycles for the reclaim block, the swap routine to designate a different block of memory to use as the reclaim block if the number of write cycles for the reclaim block exceeds a threshold.

16. An apparatus according to claim 15, the swap routine to designate the different block of memory based on a last-in first-out selection algorithm to designate the last available memory block of managed code memory as the reclaim block, and designate the next to last available memory block of the managed code memory as the reclaim block if the number of write cycles for the reclaim block exceeds a threshold.

17. An apparatus according to claim 13, the swap routine to maintain a list of blocks available to designate as the reclaim block, and to designate a block from among the blocks on the list.

18. A system comprising:
a flash device having a dynamically designated reclaim block to reclaim a section of stored code;
a processor coupled with the flash device to obtain instructions from the flash device for execution; and
a transceiver having an antenna communicatively coupled with the processor to receive or transmit communications to or from the processor.

19. A system according to claim 18, the flash device further including memory management to designate the reclaim block based at least in part on a selection algorithm that designates the next available memory block adjacent to stored code within a managed code section of the flash device.

20. A system according to claim 18, the flash device further including memory management to maintain a counter to indicate a number of reclaims performed on stored code, and designate the reclaim block when the number of reclaims reaches a threshold.

21. An apparatus according to claim 13, wherein the memory comprises a non-volatile memory.
